(19) United States
(12) Patent Application Publication
(10) Pub. No.: US 2010/0138081 A1
(43) Pub. Date: Jun. 3, 2010

(54) Methods and Systems for Controlling Vehicles

(76) Inventors: Angelo Doukas, New South Wales (AU); Nick Fondas, New South Wales (AU)

Correspondence Address: POLSINELLI SHUGHART PC, 700 W. 47TH STREET, SUITE 1000, KANSAS CITY, MO, 64112-1802, US

(21) Appl. No.: 12/601,436

(22) PCT Filed: May 26, 2008
(86) PCT No.: PCT/AU2008/000737

§ 371 Date: Jan. 22, 2010

(30) Foreign Application Priority Data
May 25, 2007 (AU) 200790281.4

(51) Int. Cl. G06F 7/00; G01S 13/58; G01S 15/00; G01S 13/00; G01S 13/08

(52) U.S. Cl. 701/2; 367/99; 342/147; 342/118

(57) ABSTRACT

The present invention provides a system and method of controlling a vehicle. The method includes the steps of: Providing a transmitter arranged to transmit in the microwave frequency range; providing a receiving means on the vehicle, receiving the signal, and calculating the azimuth of the transmitter with respect to the vehicle. The vehicle is controlled based on the calculated azimuth.

### TECHNICAL FIELD

This invention relates to methods and systems for controlling vehicles and has particular application to an autonomous golf trolley.

### BACKGROUND OF THE INVENTION

Golf bags are an essential piece of golfing equipment that are used to carry a golfer's clubs while traversing around the course. Often golf bags will be coupled to a set of wheels (i.e. a trolley) thereby allowing the golfer to readily wheel the golf bag around the course.

Some trolleys incorporate an electric motor which powers the trolley wheels so as to assist the golfer in facilitating movement of the bag. Such trolleys (which are often referred to as electric buggies) can prove invaluable where the course is very steep and can often save the golfer expending vast amounts of energy that would ordinarily be required to pull the trolley up hills, etc.

### SUMMARY OF THE INVENTION

In a first aspect the present invention provides a method of controlling a vehicle including the steps of: providing a transmitter arranged to transmit in the microwave frequency range; providing a receiving means on the vehicle; receiving the signal; calculating the azimuth of the transmitter with respect to the vehicle; and controlling the vehicle based on the calculated azimuth.

In a second aspect the present invention provides a system for controlling a vehicle including: a transmitter arranged to transmit in the microwave frequency range; receiving means which is arranged to be fitted to a vehicle and arranged to receive the signal; calculating means arranged to calculate the azimuth of the transmitter with respect to the vehicle; and control means for controlling the vehicle based on the calculated azimuth.

The vehicle may be a golf trolley and the transmitter is provided on a golf player.

The receiving means may include a reflector that rotates and means for determining the rotational position of the reflector and the azimuth is calculated based on the rotational position of the reflector.

The system may further comprise a distance measurement module operable to measure the distance between the vehicle and the transmitter, whereby the vehicle is additionally controlled to substantially maintain a set distance therebetween. The distance measurement module may comprise one or more ultrasonic transceivers.

The system may further comprise a system in accordance with the fourth aspect operable to control the vehicle in the event that the receiving means fails to receive the microwave signal.

In a third aspect the present invention provides a method of controlling a vehicle including the steps of: providing a sensing means arranged to sense either the orientation or acceleration of a body; transmitting the output of the sensing means; providing a receiver on the vehicle, receiving the transmitted signals; and controlling the vehicle based on the received signals.

In a fourth aspect the present invention provides a system for controlling a vehicle including: sensing means arranged to sense either the orientation or acceleration of a body; transmitting means for transmitting the output of the sensing means; a receiver which is arranged to be fitted to a vehicle and which is arranged to receive the transmitted signals; and control means for controlling the vehicle based on the received signals.

In a fifth aspect the present invention provides a radar arrangement comprising a split dish including at least two dish portions arranged at an angle relative to each other in order to provide a field of view larger than the field view of a single dish of comparable size to the relative size of the dish portions.

### BRIEF DESCRIPTION OF THE DRAWINGS

An embodiment of the present invention will now be described, by way of example only, with reference to the accompanying drawings, in which:

FIG. 1 is a side view of a an arrangement according to an embodiment of the invention;

FIG. 2a is a close up of the receiver provided on the golf trolley of FIG. 1;

FIG. 2b is a top view of the receiver of FIG. 2;

FIG. 3 is a close up of an alternative receiver provided on the golf trolley of FIG. 1;

FIG. 4a is an overhead view illustrating calculation of an azimuth angle;

FIG. 4b is a schematic view of the auxiliary system modules;

FIG. 5 is an oscilloscope screen shot showing scanner output measurements for a beacon positioned at 90 degrees; and

FIG. 6 is a diagram comparing true and measured angles.

### DETAILED DESCRIPTION

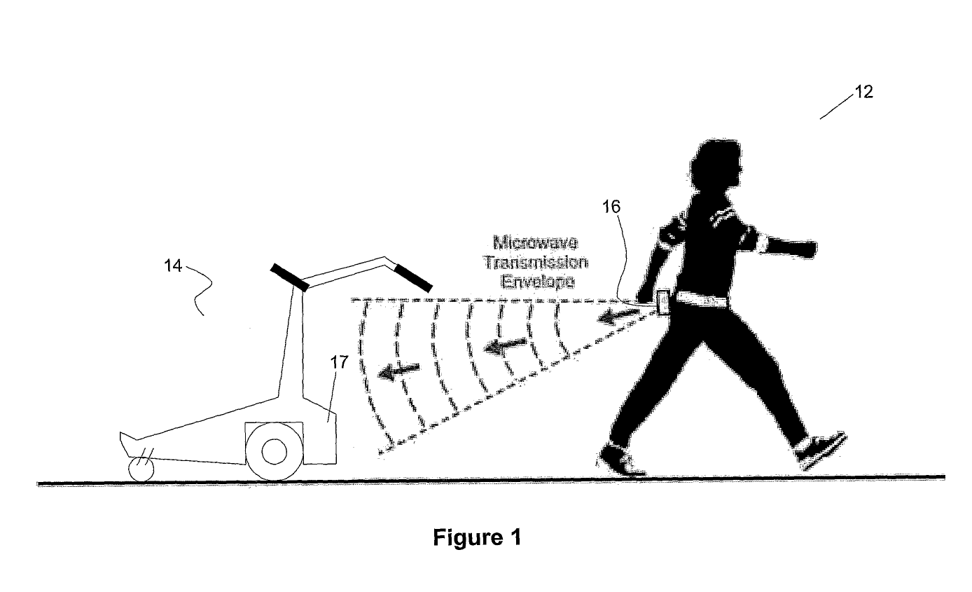

Referring to FIG. 1, a system for controlling a vehicle is illustrated in a scenario of a golf player 12 and a golf trolley 14. Golfer wears a transmitting unit 16 which includes a transmitter in the form of a 24 GHz microwave transmitter (part no M09060). Receiving means in the form of dish arrangement 17 is provided on trolley 14.

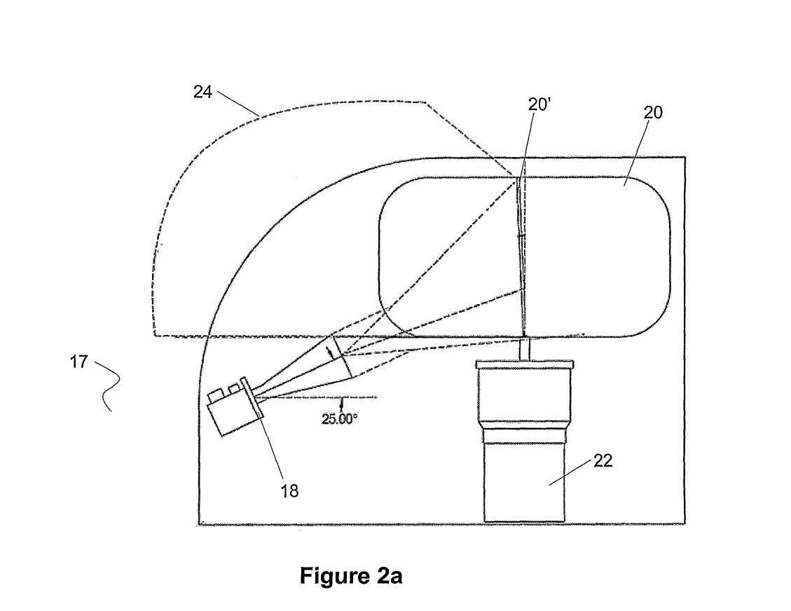

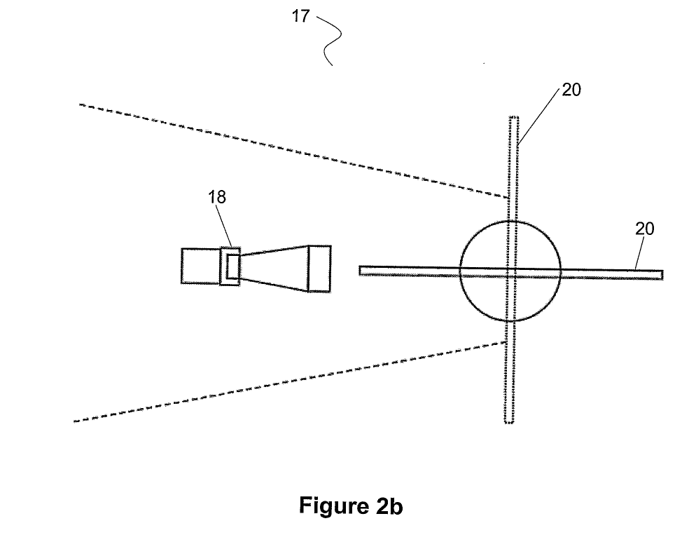

Referring to FIG. 2a, the dish arrangement 17 of FIG. 1 is shown in more detail and includes a 24 GHz microwave receiver and horn 18 (part no M9071 (Gunn Module) & ‘K Band’ horn). A reflector in the form of dish 20 is mounted to the shaft of a geared DC motor 22 which operates to rotate the dish 20 at a constant 750 revolutions per minute. The use of a geared motor ensures sufficient torque is available to the motor 22 to minimise the effects of vibration and crosswind on the repeatability of the dish rotation. The position of the dish is synchronised via an optical sensor (not shown) which provides an output pulse at the completion of each revolution of dish 20. In the illustrated embodiment, this dish arrangement 17 is located at the end of the trolley 14 which is closest to the main driving wheels. It will be understood by persons skilled in the art, however, that the dish arrangement 17 could be located in other convenient positions on the golf trolley 14.

The dotted lines show the profile of the field of view envelope for the receiving dish 20 as well as the expected reflection envelope to the microwave horn 18.

In operation, a microwave signal is constantly transmitted from the unit 16 (in the illustrated embodiment being worn on the waist of the golfer at their back and pointing slightly down from the horizontal). This microwave signal is received by the dish arrangement 17 and is used to determine the azimuth angle θ between the direction faced by the golfer 12 and the direction faced by the trolley 14. The objective is to always align the trolley 14 (using techniques outlined in more detail in subsequent paragraphs) to point directly at the transmitting unit 16 so that the azimuth angle becomes zero. In an embodiment, microwaves are additionally transmitted by the dish arrangement 17, and the Doppler Shift/Beat is used to detect the beacon signature, which is at a known offset frequency.

In FIGS. 2a and 2b, dish 20 is shown in two rotational positions indicated by reference numerals 20 and 20′.

As is evident from position 20′, dish 20 is tilted slightly towards the receiving horn 18 so that the height of the reception envelope 24 is increased based on the tilt of the envelope up or down for each half revolution depending upon which side of the dish 20 is reflecting. According to the illustrated embodiment the dish is tilted at a five degree angle with respect to the horizontal.

Trolley 14 further includes calculating means embodied in a microcontroller which runs appropriate software to determine the side of the dish 20 (front or back) that is reflecting the incoming microwave signal based on the output of the optical sensor. The microcontroller is also operable to calculate the azimuth angle from the measurements received from the dish arrangement 17; the distance to trolley; and control power to the trolley wheels accordingly.

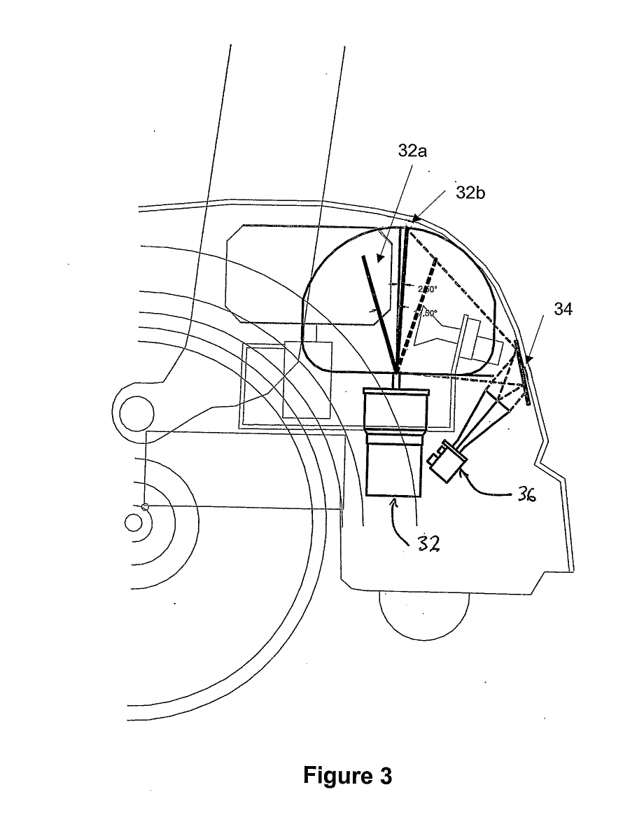

At FIG. 3 there is shown an alternate configuration which may be used in place of the radar configuration described generally at FIGS. 2a and 2b. The radar arrangement 32 of FIG. 3 includes a split dish arrangement 32a and 32b, which is arranged to substantially increase the radar envelope compared to a conventional single dish arrangement of a comparable dish size. Moreover, it will be noted that the split dish arrangement results in a radar dish which is substantially smaller than the radar dish generally described at FIGS. 2a and 2b. By increasing the field of view (utilising the split dish arrangement), the radar configuration is much more likely to capture the directional signal output by the unit 16, worn on the waist of the golfer at their back. Moreover, as clearly seen in FIG. 3, the split dish, on receiving the signal, bounces the signal onto a mirror (i.e. any suitable means for reflecting a microwave signal) 34, and into a receiver 36. In addition to providing a smaller more compact radar arrangement, this embodiment may also be mounted further forward on the chassis of the trolley 14, which may provide further advantages depending on the desired layout and configuration of the trolley 14. It will be understood that either radar arrangement may be utilised, as required by particular design principles or the desires of the manufacturer. Such variations are within the purview of a person skilled in the art.

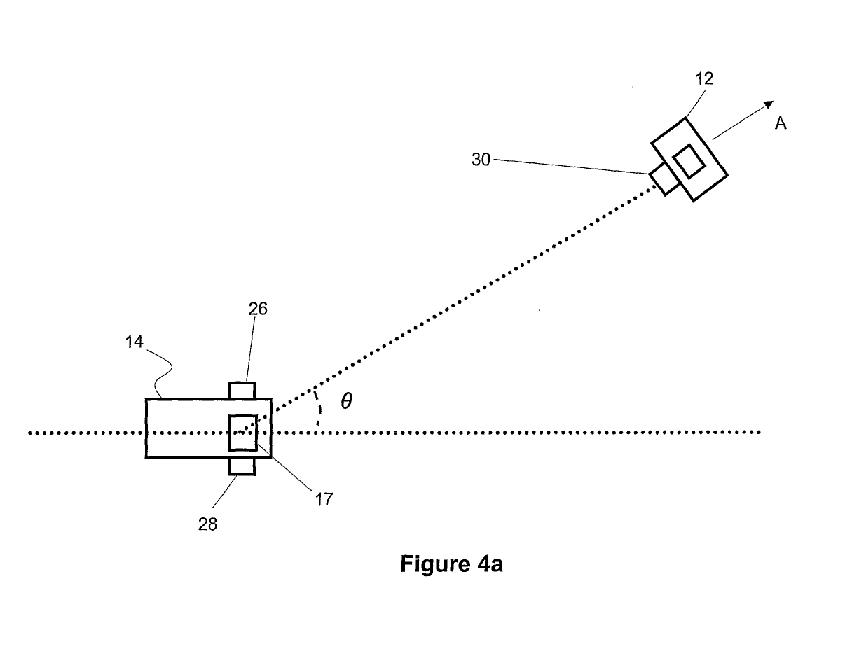

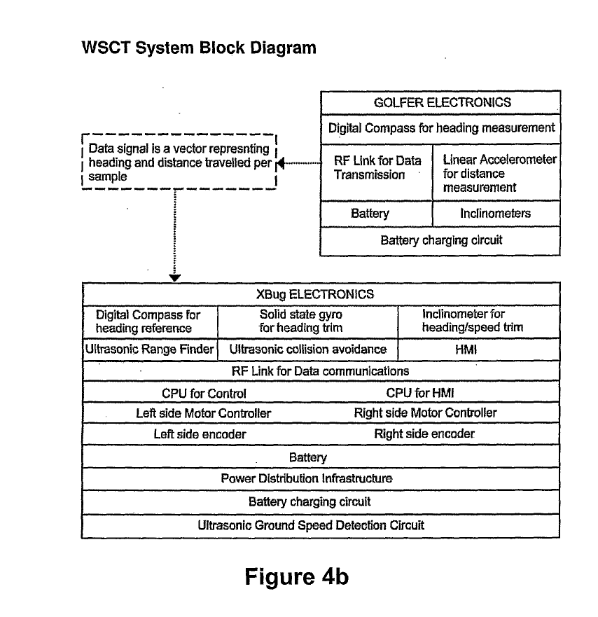

Trolley control will now be described in more details with specific reference to FIG. 4a. In the FIG. 4a embodiment, trolley control is based on measuring the azimuth and continually orienting the trolley 14 to the golfer 12 while maintaining a specified following distance. The specified following distance may be automatically set by the microcontroller, or alternatively can be manually adjusted using buttons provided on the transmitting unit 16. According to the embodiment described herein, the specified distance is 1.5 metres. In FIG. 4a, golfer 12 is shown walking in direction A. The microwave transmission from transmitting unit 16 is reflected by dish 20 at dish arrangement 17. By determining the rotational position of dish 20 when microwaves are received by horn 18, it is possible to deduce azimuth angle θ (see results section below for more detail on angle determination). This data is then stored in volatile memory by the microcontroller and subsequently utilised to control an electric motor which powers the trolley wheels.

When azimuth angle θ is known, trolley 14 can be controlled to turn to face the golfer 12. Trolley turns by applying different rates of rotation to wheels 26, 28 to change the heading of trolley. Trolley 14 aims to reduce azimuth angle to zero, that is to say, trolley 14 always aims to face directly towards the player 12.

The azimuth sensing sub-system is only used for sensing the angle as described above. The control of the movement of the trolley 14 depends on another variable and that is the maintenance of the distance between the golfer and the trolley. In an embodiment, this distance is measured using an array of ultrasonic transceivers based on sending an ultrasonic pulse out from the transceiver directed at the golfer 14 and timing the echo to extract distance. In an embodiment, the array of ultrasonic transceivers may additionally be utilised to detect obstacles that lie in the trolley's path and advise the micro controller accordingly. In an embodiment if only one obstacle is detected by the transceiver system, the microcontroller assumes that the obstacle is the golfer and hence no de-activation of power to the wheels is initiated.

The arrangement of FIG. 1 includes an auxiliary control system. This auxiliary system provides a range and angle measurement independently of the microwave and ultrasonic system described above and is used for real time back up to compensate for bad data from the primary system which can occur due to terrain effects such as loss of line of sight to the microwave transmitter.

With additional reference to the system schematic of FIG. 4b, the auxiliary system includes two parts. The first part is coupled to the golfer and includes various sensors mounted inside a body in the form of unit 30. In the illustrated embodiment, the unit 30 in integrated into the transmitting unit 16. The sensors in the unit 30 include a digital compass (part no HMC6352), and a linear tri-axial accelerometer (not shown) used to measure the acceleration of the golfer (which can be converted into walking speed and thus distance travelled, using techniques known to those skilled in the art). A side benefit of utilising such an accelerometer is that the energy consumption of the golfer during a round of golf can be computed and displayed on their transmission unit 16 via, for example, an LCD display or the like. Unit 30 further includes a wireless RF transmitter which transmits the outputs of these sensors to an RF receiver incorporated into the other part of the auxiliary system mounted on board trolley 14.

The second part of the auxillary system is fitted to the trolley 14 and includes a digital compass and distance measuring means operable to measure the distance travelled. The distance measuring means may comprise, for example, an accelerometer or odometer, or combination of the two. Using such an arrangement allows the trolley 14 to affectively replicate the movements of the player 12 as sensed by the sensors in unit 30. This allows the trolley 14 to continue to follow the player 12 when the microwave azimuth detecting system is not operating. When the primary microwave control system comes back into operation, such as by line of sight to the transmitter being restored, the microcontroller switches control back to the primary control system. In an embodiment a solid state gyroscope such as the ENC-033 piezo-electric gyroscope manufactured by Murato of Japan, may also be incorporated into the trolley side auxiliary system to sense changes in trolley direction and facilitate heading trim.

The odometer provided on trolley 14 may also incorporate visual detecting means to verify distance travelled by monitoring the ground surface. This system can assist to overcome odometry errors introduced by events such as wheel slip.

In the preceding paragraphs, it has been stated that the radar arrangement, in conjunction with the transmitter unit 16 is used as the main system for orienting the trolley 14 with the auxiliary system (as previously described) being used as a back up when the radar system is otherwise unavailable. However, it will be understood that the auxiliary system may also be used in conjunction with the radar system to ensure that the golf trolley 14 follows a “smooth” path. That is, the auxiliary system could be invoked periodically (i.e. irrespective of whether the main control system is functioning adequately), to make small adjustments to the path of travel of the trolley 14.

### Example Implementation Results

The performance of the dish arrangement 17 was tested using an example set up comprising identical components to those previously described. Measurements were made at a range of 1.6 m with the transmitter (hereafter “beacon”) positioned slightly higher than the dish arrangement (hereinafter “scanner”). The scanner was rotated and measurements made at various angles by capturing output trace images mapped by an oscilloscope. These images were then processed to determine the position of the beacon pulse with respect to the motor shaft reference pulse.

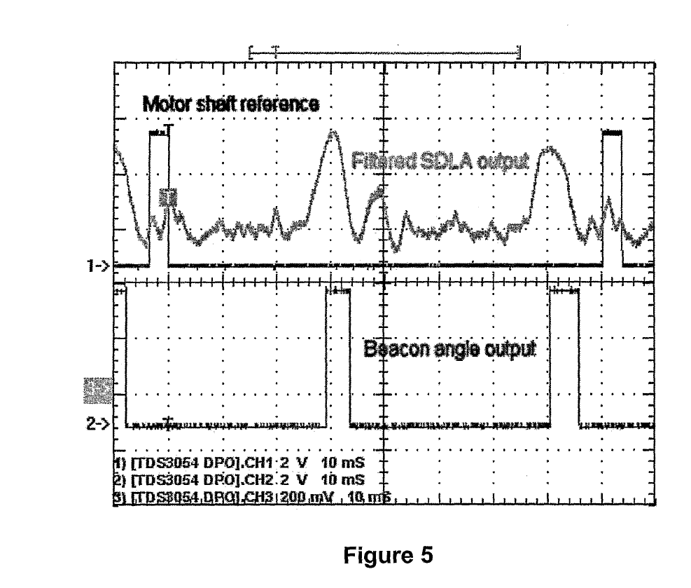

In addition to being offset, it was determined that the width of the beacon TTL pulse varied depending on the shape of the received signal (see FIG. 5). To accommodate this, the beacon pulse position was taken to be the midpoint between the rising and falling edges of the pulse. The reference pulse time was taken at the rising edge. Because of slight variations in the motor speed from measurement to measurement, the period between pairs of motor reference pulses was used to determine the rotation time.

The table below (Table 3) shows the measured data (in screen pixels) at each of the angles. Because of the total view, some of pulses could not be seen, in which case the cell has been left blank.

TABLE 3
Measured Data from the Oscilloscope Images

| Angle | | | | | | | | |
|---|---|---|---|---|---|---|---|---|
| (deg) | M1 | M2 | L1 | L2 | L3 | R1 | R2 | R3 |
| −135 | 69 | 426 | 142 | 320 | | 154 | 332 | |
| −90 | 69 | 427 | 115 | 293 | 469 | 137 | 313 | |
| −45 | 69 | 436 | 93 | 280 | 466 | 115 | 300 | 488 |
| −30 | 69 | 425 | 87 | 260 | 434 | 101 | 276 | 449 |
| 0 | 69 | 429 | 78 | 259 | 440 | 88 | 269 | 449 |
| 30 | 69 | 428 | 56 | 271 | 411 | 78 | 254 | 433 |
| 45 | 69 | 430 | 48 | 230 | 411 | 72 | 253 | 435 |
| 90 | 70 | 414 | | 203 | 375 | 49 | 221 | 396 |
| 135 | 69 | 430 | | 188 | 368 | | 200 | 381 |

In this table M1 and M2 are the counts to the rising edges of the motor encoder pulses. L1,L2 and L3 are the counts to the rising edges (left side) of the three beacon return pulses and R1,R2 and R3 are the counts to the falling edges (right side) of the pulses.

Table 4 below shows the values calculated from the measured data.

TABLE 4
Processed Data from Oscilloscope Images

| | (R1 + L1)/2 − | (R2 + L2)/2 − | (R3 + L3)/2 − | | | | | | |
|---|---|---|---|---|---|---|---|---|---|
| M2 − M1 | M1 | M1 | M2 | Angle 1 | Correct 1 | Angle 2 | Correct 2 | Angle 3 | Correct 3 |
| 357 | 79.00 | 257.00 | | 159.33 | 131.33 | 158.32 | 128.32 | | |
| 358 | 57.00 | 234.00 | | 114.64 | 88.64 | 110.61 | 80.61 | | |
| 367 | 35.00 | 221.00 | 41.00 | 68.66 | 40.66 | 73.57 | 43.57 | 80.44 | 49.44 |
| 356 | 25.00 | 199.00 | 16.50 | 50.56 | 22.56 | 42.47 | 12.47 | 33.37 | 2.37 |
| 360 | 14.00 | 195.00 | 15.50 | 28.00 | 0.00 | 30.00 | 0.00 | 31.00 | 0.00 |
| 359 | −2.00 | 193.50 | −6.00 | −4.01 | −32.01 | 28.08 | −1.92 | −12.03 | −43.03 |
| 361 | −9.00 | 172.50 | −7.00 | −17.95 | −45.95 | −15.96 | −45.96 | −13.96 | −44.96 |
| 344 | | 142.00 | −28.50 | | | −62.79 | −92.79 | −59.65 | −90.65 |
| 361 | | 125.00 | −55.50 | | | −110.69 | −140.69 | −110.69 | −141.69 |

The value M2-M1 is the total count for one 360° scan which is used as a reference for the other counts.

(R1-L1)/2−M1 determines the total count to the centre of the first beacon return relative to the motor pulse

Angle 1 is just the ratio between the beacon return count and the total count over 360° scaled by 2×360 to accommodate the mirror doubling angle

$$Angle 1 = \frac{( R 1 - L 1 ) / 2 - M 1}{M 2 - M 1} \times 2 \times 360$$

It can be seen that for a true angle of 0°, the measured angle in this example is 28°, so the value Correct 1 is just Angle 1 offset by this correction factor.

In the same way Angle 2 and Correct 2 can be calculated. However, because the reflection is off the reverse side of the mirror, an additional factor of 2×180° must be subtracted from the angle

$$Angle 2 = \frac{( R 2 - L 2 ) / 2 - M 1}{M 2 - M 1} \times 2 \times 360 - 360$$

Finally, Angle 3 is calculated in the same way that Angle 1 is calculated except that it is taken with reference to the second scan pulse

$$Angle 3 = \frac{( R 1 - L 1 ) / 2 - M 2}{M 2 - M 1} \times 2 \times 360$$

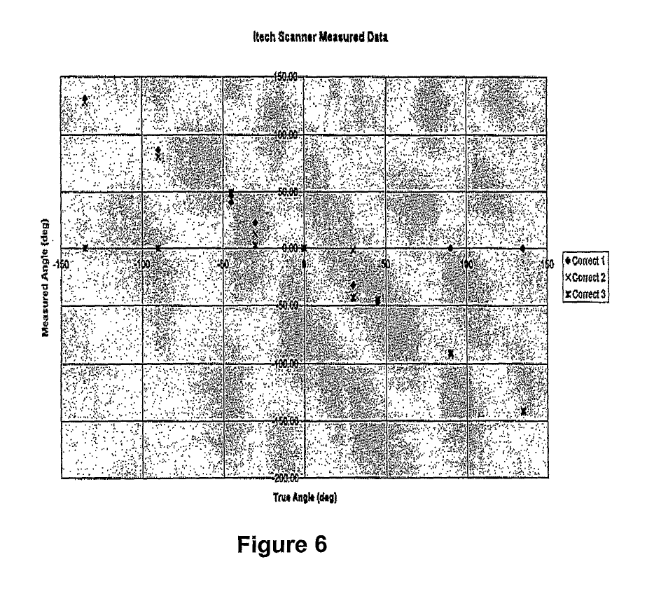

Plotting the measured results shows that this scanner produces accurate measurements under most conditions, right out to +/−135°. The plotted measurements are shown in FIG. 6.

The above results show that with calibration, the scanner is capable of measuring the angle to the beacon with a single shot accuracy of better than 5°. Because two independent angle measurements are made every 100 ms, it is possible to decrease the measurement uncertainty by averaging over a number of cycles.

It will be understood that an alternative microwave frequency may be utilised by the unit 16 and dish arrangement 17 and should not be seen as limited to that described herein.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A system for controlling a vehicle, the system comprising:
a transmitter coupled to a target object and arranged to transmit both a microwave signal and movement data representative of a movement of the object; and
a receiving module coupled to the vehicle and arranged to receive both the microwave signal and movement data, the receiving module comprising:
a first receiving arrangement which is arranged to utilise the microwave signal to determine an azimuth of the transmitter module with respect to the vehicle and output a first control signal for controlling the vehicle based on the determined azimuth;
a second receiving arrangement which is arranged to output a second control signal for controlling the vehicle based on the movement data; and
a control module arranged to select at least one of the control signals for controlling the vehicle, based on a predetermined criterion.

2. A system in accordance with claim 1, wherein the control module selects the first control signal to be utilised for primarily controlling the vehicle whilst ever the microwave signal is detected by the receiving module.

3. A system in accordance with claim 2, wherein the control module is arranged to additionally select the second control signal to be utilised in controlling the vehicle on a periodic basis.

4. A system in accordance with claim 1, wherein the control module selects the second control signal to be utilised for primarily controlling the vehicle when the microwave signal is not detected by the receiving module.

5. A system in accordance with claim 1, wherein the first receiving arrangement further comprises a distance measurement module for determining the distance between the vehicle and the object and whereby the vehicle is additionally controlled so as to substantially maintain a specific distance there between.

6. A system in accordance with claim 5, wherein the distance measurement module comprises one or more ultrasonic sensors arranged to transmit an ultrasonic sensing signal in the direction of the object and process the reflected signal to determine the distance.

7. A system in accordance with claim 5, wherein the control module selects the second control signal for primarily controlling the vehicle when an obstacle is detected by the distance measurement module, as determined from the reflected signals.

8. A system in accordance with claim 1, wherein the microwave signal is directed outwardly away from a face which is opposite to the direction of travel of the object.

9. A system in accordance with claim 8, wherein the first receiving arrangement comprises a rotating dish and reflector arrangement arranged to determine the azimuth angle between a direction faced by the object and a direction faced by the vehicle, based on the rotational position of the reflector.

10. A system in accordance with claim 9, wherein the vehicle is controlled so as to substantially maintain an azimuth angle of zero degrees.

11. A system in accordance with claim 1, wherein the transmitter generates vector data that is representative of the object's movement at any given time.

12. A system in accordance with claim 11, whereby the second control signal is arranged to control the vehicle so as to substantially track the object's movement.

13. A system in accordance with claim 11, wherein the transmitter comprises a digital compass and accelerometer, the outputs of which are utilised to continuously generate the vector data.

14. A method for controlling a vehicle, the method comprising:
providing a transmitting module coupled to a target object and arranged to transmit both a microwave signal and movement data representative of a movement of the object;
providing a receiving module coupled to the vehicle and arranged to receive both the microwave signal and movement data, the receiving module comprising:
a first receiving arrangement which is arranged to utilise the microwave signal to determine an azimuth of the transmitter module relative to the vehicle and output a first control signal for controlling the vehicle based on the determined azimuth;
a second receiving arrangement which is arranged to output a second control signal for controlling the vehicle based on the movement data; and
selecting at least one of the control signals for controlling the vehicle based on a predetermined criterion.

15. A method in accordance with claim 14, comprising the further step of selecting the first control signal to be utilised for primarily controlling the vehicle whilst ever the microwave signal is detected by the receiving module.

16. A method in accordance with claim 15, comprising the further step of additionally selecting the second signal to be utilised in controlling the vehicle on a periodic basis.

17. A method in accordance with claims 14, wherein the control module selects the second control signal to be utilised for primarily controlling the vehicle when the microwave signal is not detected by the receiving module.

18. A method in accordance with claims 14, wherein the first receiving arrangement is further arranged to determine a distance between the object and the vehicle and whereby the vehicle is additionally controlled so as to substantially maintain a specific distance there between.

19. A method in accordance with claim 18, comprising the further step of transmitting an ultrasonic sensing signal in the direction of the object and processing the reflected signal to determine the distance.

20. A method in accordance with claim 18, comprising the further step of the control module selecting the second control signal for primarily controlling the vehicle when an obstacle is detected by the distance measurement module, as determined from the reflected signals.

21. A method in accordance with claims 14, wherein the microwave signal is directed outwardly away from a face opposite the object's direction of travel.

22. A method according to claim 21, wherein the first receiving arrangement comprises a rotating dish and reflector arrangement arranged to determine the azimuth angle between a direction faced by the object and a direction faced by the vehicle based on the rotational position of the reflector.

23. A method in accordance with claim 22, wherein the vehicle is controlled so as to substantially maintain an azimuth angle of zero degrees.

24. A method in accordance with claims 14, comprising the further step of generating vector data that is representative of the object's movement at any given time and whereby the second control signal is arranged to control the vehicle so as to substantially track the object's movement.

25. A method in accordance with claim 23, wherein the transmitter comprises a digital compass and accelerometer, the outputs of which are utilised to continuously generate the vector data.

26. A system in accordance with claim 1, wherein the vehicle comprises at least one driving wheel controlled by the control module for allowing the vehicle to track the movement of the object.

27. (canceled)

28. (canceled)
